(19) United States
(12) Patent Application Publication
(10) Pub. No.: US 2019/0340452 A1
(43) Pub. Date: Nov. 7, 2019

(54) IMAGE PROCESSING APPARATUS, IMAGE PROCESSING METHOD, AND COMPUTER-READABLE RECORDING MEDIUM RECORDING IMAGE PROCESSING PROGRAM

(71) Applicant: FUJITSU LIMITED, Kawasaki-shi (JP)

(72) Inventors: Yoshihisa Asayama, Kawasaki (JP); Kimitaka MURASHITA, Atsugi (JP)

(73) Assignee: FUJITSU LIMITED, Kawasaki-shi (JP)

(21) Appl. No.: 16/511,075

(22) Filed: Jul. 15, 2019

Related U.S. Application Data
(63) Continuation of application No. PCT/JP2018/000986, filed on Jan. 16, 2018.

(30) Foreign Application Priority Data
Jan. 31, 2017 (JP) 2017-016240

(51) Int. Cl. G06K 9/00; B60R 21/015

(52) U.S. Cl. CPC G06K 9/00838; B60R 21/01538; G06K 9/00362

(57) ABSTRACT

An image processing apparatus performs of: acquiring an image; calculating a feature amount of each pixel of an object in the image; extracting a change region including a background and the object based on difference information in pixels; identifying the image from a start to an end of the partial change in the background; determining whether the calculated feature amount is similar to the feature amount of background model information regarding a feature amount of each pixel constituting the background; when determining dissimilarity and when the pixel determined to be dissimilar is the pixel included in the change region of the image, determining that the pixel is the pixel that corresponds to the background having a change; registering the information of the feature amount of the pixel determined to be dissimilar onto the background model information; and extracting the object from the image using a background difference.

### CROSS-REFERENCE TO RELATED APPLICATION

This application is a continuation application of International Application PCT/JP2018/000986 filed on Jan. 16, 2018 and designated the U.S., the entire contents of which are incorporated herein by reference. The International Application PCT/JP2018/000986 is based upon and claims the benefit of priority of the prior Japanese Patent Application No. 2017-16240, filed on Jan. 31, 2017, the entire contents of which are incorporated herein by reference.

### FIELD

The embodiment relates to an image processing apparatus, an image processing method, and an image processing program.

### BACKGROUND

As one of the representative image processing methods for extracting a moving object from a captured image, in a background subtraction method, a background image excluding the target is preliminarily captured and the captured background image is compared with a newly captured image to extract a region changed from the background image, as an object.

Related art is disclosed in Japanese Laid-open Patent Publication No. 2012-238175, and Japanese Laid-open Patent Publication No. 2007-323572.

### SUMMARY

According to an aspect of the embodiments, an image processing apparatus includes: a memory; a processor coupled to the memory and configured to perform a processing of: acquiring an image including at least a moving object; storing information regarding a feature amount of each of pixels constituting a background of the object in the acquired image as background model information in a storage; controlling to extract the object from the image in which the object and a part of the background change in conjunction with each other based on the background model information; calculating a feature amount of each of pixels in the acquired image; extracting a change region including the background and the object for each of the images based on difference information in pixels having a same type of feature amount for each of pixels in the image sequentially acquired; identifying the image from a start to an end of the partial change in the background; determining whether the calculated feature amount is similar to the feature amount of the background model information stored in the storage, for each of the pixels of the image in which the end of the partial change in the background is identified; when determining dissimilarity and when the pixel determined to be dissimilar is the pixel included in the change region of the image from the start to the end of the partial change in the background, determining that the pixel is the pixel that corresponds to the background having a change; registering the information of the feature amount of the pixel determined to be dissimilar onto the background model information to update the background model information; and extracting the object from the image using a background difference based on the updated background model information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating a functional configuration of an image processing apparatus according to a first exemplary embodiment.

FIG. 2 is a view illustrating an example of feature amount registration information as background model information associated with each of pixels.

FIG. 3 is a view illustrating a hardware configuration of the image processing apparatus in the first exemplary embodiment.

FIG. 4 is a flowchart illustrating a flow of control from a point when an image processing apparatus acquires an image in an autonomous driving vehicle to a point when the apparatus transmits image information of a contour of an occupant to the autonomous driving system.

FIG. 5 is a flowchart illustrating an example of a flow of control of background model information update processing.

FIG. 6 is a flowchart illustrating a flow of control of determining by the autonomous driving system in the first exemplary embodiment whether the occupant is in a drivable posture on the basis of the image information of the contour of the occupant transmitted from the image processing apparatus and deciding whether to switch to manual driving.

FIG. 7 is a flowchart illustrating a flow of control of determining by the autonomous driving system in the second exemplary embodiment whether the occupant is in an abnormal posture on the basis of the image information of the contour of the occupant transmitted from the image processing apparatus and deciding an action to take.

### DESCRIPTION OF EMBODIMENTS

The background, however, is not constant and might change, making it difficult to extract an object in the background subtraction method, in some cases. For example, in an autonomous driving system under development, there is a need to extract an occupant from an image obtained by photographing the inside of the vehicle in order to confirm the presence and the posture of the occupant at the time of switching the setting from autonomous driving to manual driving. The background subtraction method, at this time, includes a problem that, in a case where a seat state is changed by reclining or sliding the seat, an image obtained would be an image of the occupant and the seat changing in conjunction with each other, leading to extraction of the state-changed seat as a moving object together with the occupant. In order to solve such a problem, various proposals may be made on an image processing method of extracting an object even in a case where there is a change in the background.

For example, in application of the background subtraction method, a certainty level indicating the certainty as an object is used to continuously detect a region having a high probability of being the object as a foreground, thereby extracting the object. Furthermore, an object is extracted using background model information updated on the basis of a state (static, dynamic, continuous static, continuous dynamic) of each of pixels determined from a short-term past acquired image.

For example, in determination of whether a thing is an object using a discriminator with respect to the region detected as the foreground, when the foreground and the background partially or entirely overlap with each other, there might be a case where the foreground and the background are extracted together, for example, the seat and the occupant might be extracted together. For example, when the occupant as an extraction target has no movement for a long time due to falling asleep, for example, the occupant might be erroneously recognized as a background.

In one aspect, the present invention aims to provide an image processing apparatus capable of extracting an object even in an image in which the object and a part of background change in conjunction with each other.

Hereinafter, one exemplary embodiment of the present invention will be described, although the present invention is not limited to this exemplary embodiment in any manner.

The control performed by each of parts of the control means in the “image processing apparatus” of the present invention is synonymous with execution of the “image processing method” of the present invention. Accordingly, details of the “image processing method” of the invention will be clarified through the description of the “image processing apparatus” of the present invention. The “image processing program” of the present invention is to be implemented in the form of the “image processing apparatus” of the present invention by using a computer or the like as a hardware resource. Accordingly, details of the “image processing program” of the invention will be clarified through the description of the “image processing apparatus” of the present invention.

### EXEMPLARY EMBODIMENTS

### First Exemplary Embodiment

An image processing apparatus according to a first exemplary embodiment is an apparatus that performs image processing of photographing, using a digital video camera or the like, an inside of an autonomous driving vehicle in an autonomous driving system and extracts a contour of a moving occupant from the captured image. Even in a case where the occupant reclines or slides the seat and the state of the seat being a part of the background changes once, it is possible to extract the contour of the occupant alone from the image and transmit image information of the occupant's contour to the automated driving system even when the changed state continues. In the first exemplary embodiment, on the basis of the image information of the contour of the occupant transmitted by the image processing apparatus, the autonomous driving system determines whether the occupant is in a drivable posture and then sets whether to switch to manual driving or continue autonomous driving.

Note that implementation of the image processing apparatus leads to implementation of an image processing method.

The image processing apparatus according to the first exemplary embodiment sequentially acquires an image in a vehicle including at least an occupant as a moving object, and uses information of the feature amount of each of pixels constituting the background in the acquired image as a background model information to update a database (also referred to as “DB” below), and extracts the occupant from the image in which the occupant and the seat change in conjunction with each other using a background difference on the basis of the updated background model information.

Specifically, the image processing apparatus according to the first exemplary embodiment first calculates a feature amount of each of pixels in the acquired image, extracts, for each of images, a change region including the occupant and the seat on the basis of difference information in pixels having a same type of feature amount for each of pixels in the image sequentially acquired, and then, identifies an image from the start to the end of the seat state change on the basis of the change region in the sequentially acquired image.

Next, the image processing apparatus according to the first exemplary embodiment determines whether the feature amount calculated for each of pixels of the image for which identification of an end of seat state change is made is similar to the feature amount of the background model information.

In a case where the image processing unit has determined dissimilarity and when the pixel determined to be dissimilar is a pixel included in a change region of the image from the start to the end of a seat state change, the image processing unit determines that the pixel is a pixel that constitutes the seat image having a state change by reclining or sliding the seat and registers the information of the feature amount of the pixel determined to be dissimilar onto the background model information to make an update. The seat state change indicates a change in the seat state as a result of reclining or sliding the seat by the occupant. In contrast, in a case where it is determined to have similarity, it would be preferable to update a frequency of occurrence of the feature amount of the pixel determined to be similar, and when the frequency of occurrence of the feature amount in the image is a predetermined frequency or more in an image from the start to end of the seat state change, it would be preferable to determine the feature amount to be a feature amount constituting the image of a moving occupant and delete information regarding the feature amount of the pixel determined to have similarity from the background model information and make an update.

Subsequently, the image processing apparatus in the first exemplary embodiment extracts the occupant from the image using a background difference on the basis of the background model information updated as described above, and then transmits image information of the contour of the occupant to the autonomous driving system.

In this manner, in the first exemplary embodiment, the image processing apparatus extracts the occupant from the image using the background difference on the basis of the background model information updated as described above and transmits image information of the contour of the occupant to the autonomous driving system. This enables the autonomous driving system to determine whether the occupant is in a drivable posture on the basis of the image information of the contour of the occupant and to set whether to switch to manual driving or to continue autonomous driving.

Next, a functional configuration and a hardware configuration of the image processing apparatus according to the first exemplary embodiment will be described.

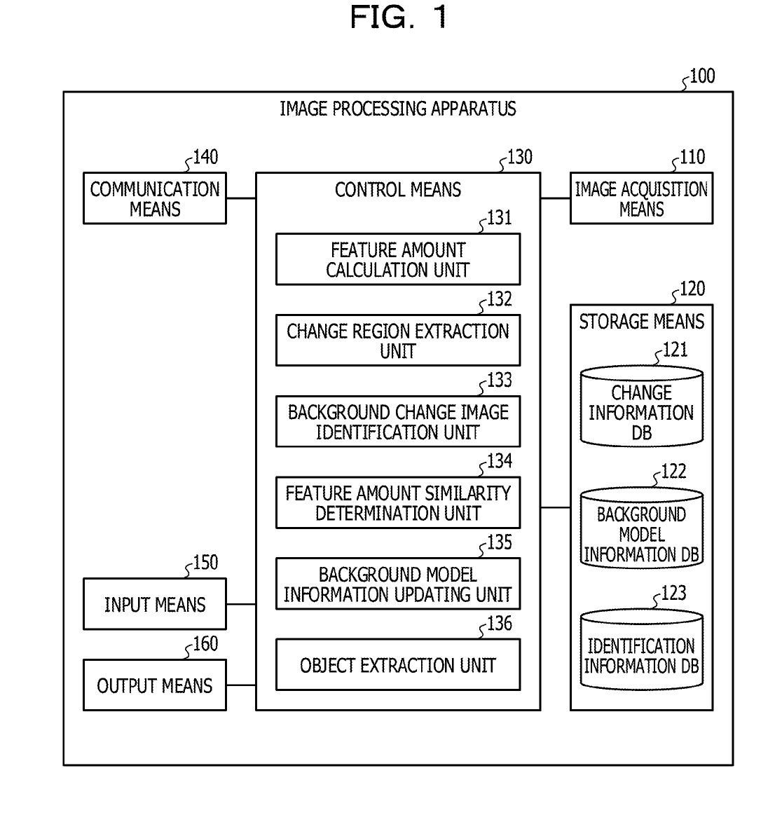

FIG. 1 is a view illustrating a functional configuration of an image processing apparatus 100 in the first exemplary embodiment.

As illustrated in FIG. 1, the image processing apparatus 100 includes an image acquisition means 110, a storage means 120, a control means 130, a communication means 140, an input means 150, and an output means 160.

<Image Acquisition Means>

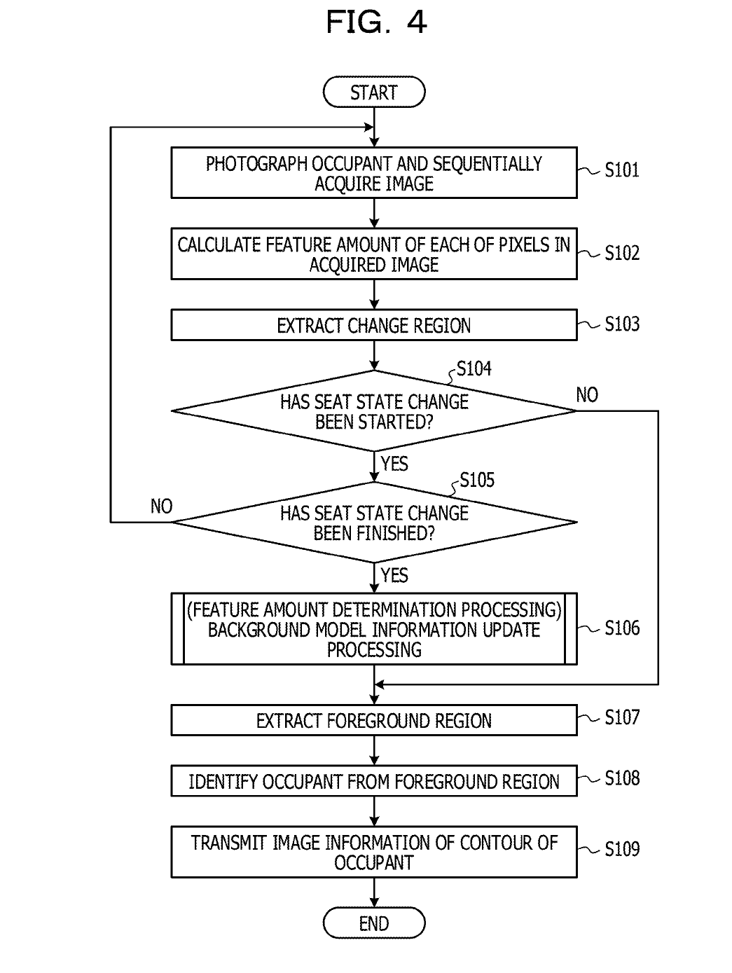

The image acquisition means 110 is installed in the vehicle compartment in order to grasp the state of the occupant inside the autonomous driving vehicle compartment, and captures an image of a moving occupant on the basis of an instruction from the control means 130 and thereby sequentially acquires images (refer to step S101 in FIG. 4).

<Storage Means>

The storage means 120 includes a change information DB 121, a background model information DB 122, and an identification information DB 123.

The change information DB 121 stores feature amount of each of pixels of a change region extracted by a change region extraction unit 132 described below.

The background model information DB 122 stores information of feature amounts of each of pixels constituting the background in the image acquired in the past, as background model information.

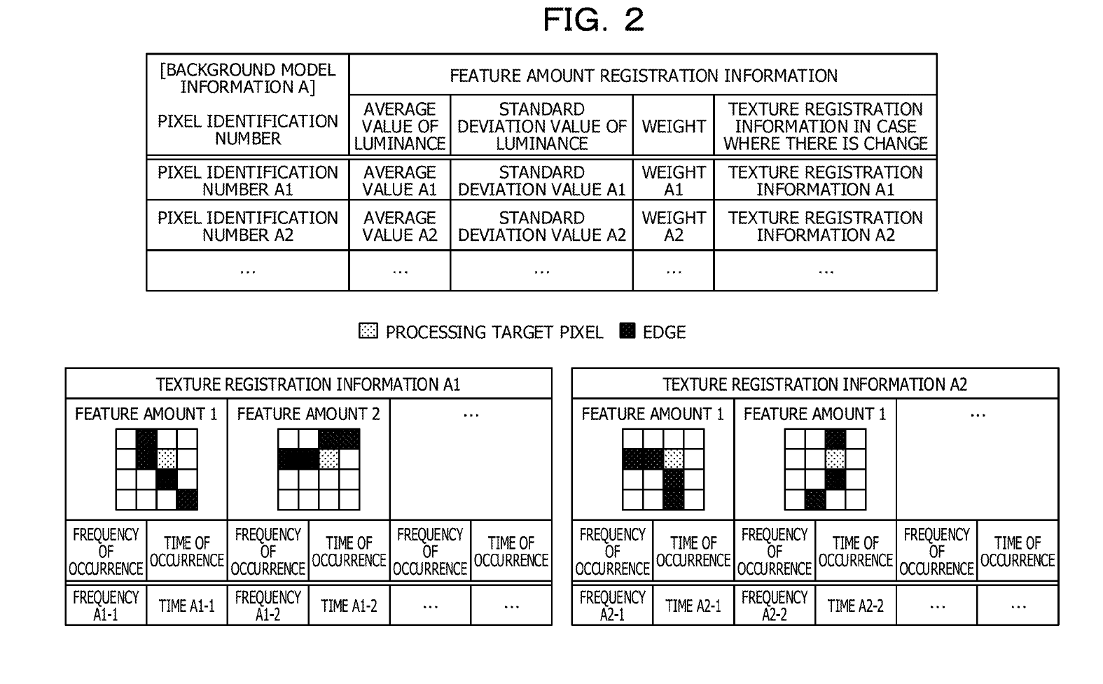

FIG. 2 is a view illustrating an example of feature amount registration information as background model information associated with each of pixels.

As illustrated in FIG. 2, the background model information DB 122 stores background model information for each of pixels, and contains feature amount registration information as the background model information.

Examples of the feature amount registration information include an average value of luminance, a standard deviation value of luminance, a weight, and texture registration information when there is a change. In the texture registration information when there is a change, one or more feature amounts are registered, and a texture shape when there is a change till a most recent image acquired by the image acquisition means 110 (hereinafter, also referred to as “current frame”) and frequency of occurrence and time of occurrence of a texture shape similar to the texture shape are updated.

The background model information is updated by registration or deletion by the background model information updating unit 135. Details of the background model information updating unit 135 will be described below.

The identification information DB 123 stores identification information for identifying an occupant in the acquired image.

The storage means 120 also stores various programs installed in the image processing apparatus 100, data generated by executing the programs, or the like, on the basis of an instruction from the control means 130.

<Control Means>

The control means 130 is a means that performs control of extracting a contour of an occupant as an object from the image in which the seat state changes, on the basis of the updated background model information, and includes a feature amount calculation unit 131, a change region extraction unit 132, a background change image identification unit 133, a feature amount similarity determination unit 134, a background model information updating unit 135, and an object extraction unit 136.

The feature amount similarity determination unit 134 and the background model information updating unit 135 perform background model information update processing described below.

—Feature Amount Calculation Unit—.

The feature amount calculation unit 131 calculates a feature amount of each of pixels in the image acquired by the image acquisition means 110 (refer to step S102 in FIG. 4).

—Change Region Extraction Unit—

The change region extraction unit 132 extracts, for each image, a change region including the seat and the occupant on the basis of difference information in pixels having a same type of feature amount for each of pixels in the sequentially acquired image (refer to step S103 in FIG. 4). In other words, the change region extraction unit 132 uses a difference between the current frame and an image (preceding frame) acquired before the most recent image, namely, uses an inter-frame difference and thereby calculates feature amount difference information of the images sequentially acquired by the image acquisition means 110. Subsequently, the change region extraction unit 132 extracts a region having a difference as a change region on the basis of the calculated difference information.

—Background Change Image Identification Unit—

The background change image identification unit 133 identifies an image from the start to the end of the seat state change on the basis of the change region in the sequentially acquired images (refer to steps S104 and S105 in FIG. 4).

Examples of a method for identifying the image from the start to the end of the seat state change include: an identification method based on the change region extracted by the change region extraction unit 132; an identification method based on seat movement obtained from controller area network (CAN) information; and an identification method using movements of a marker installed on the seat.

Examples of identification methods based on the change region include an identification method based on a change of the shape of the change region and an identification method based on a change of the area of the change region.

These methods may be used alone or in combination of two or more.

—Feature Amount Similarity Determination Unit—

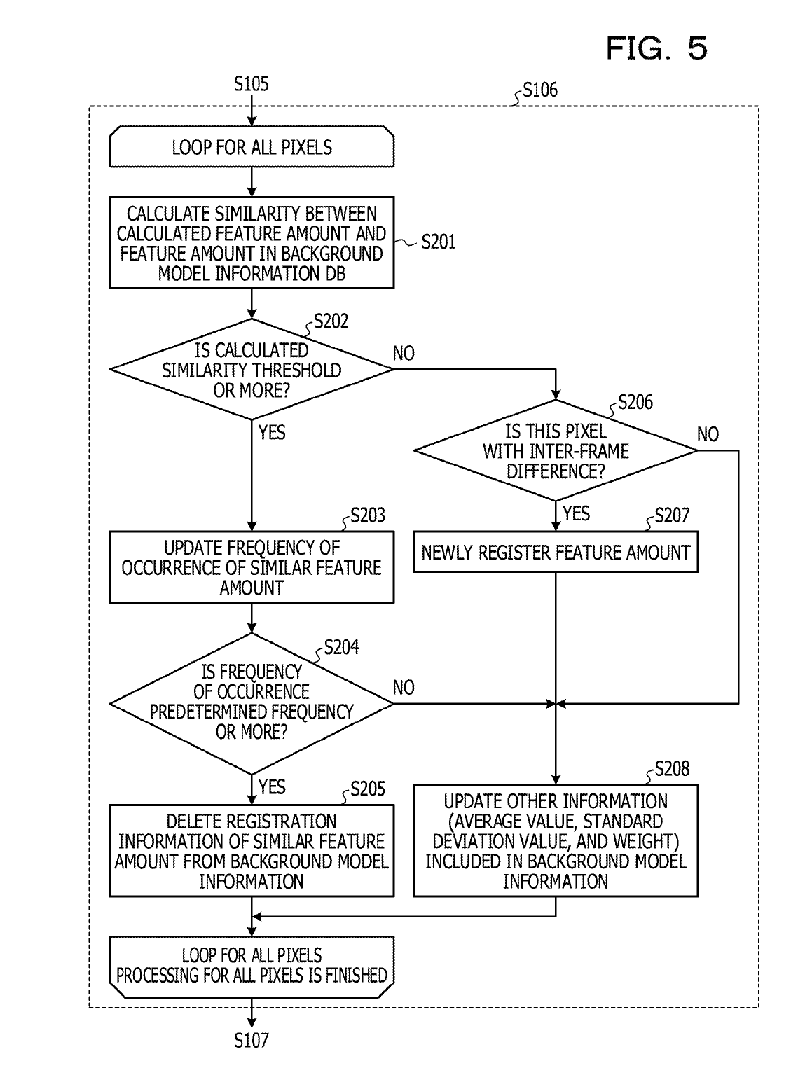

The feature amount similarity determination unit 134 determines whether the feature amount calculated by the feature amount calculation unit 131 is similar to the feature amount of the background model information stored in the background model information DB 122, for each of pixels of the image for which identification of an end of seat state change is made (refer to steps S201 and S202 in FIG. 5).

Examples of a method of determining whether the feature amount calculated by the feature amount calculation unit 131 is similar to the feature amount of the background model information stored in the background model information DB 122 include a method of first calculating a similarity between the feature amount calculated by the feature amount calculation unit 131 and the feature amount of the background model information stored in the background model information DB 122 and then determining whether the calculated similarity is a threshold or more.

—Background Model Information Updating Unit—

In a case where the feature amount similarity determination unit 134 has determined dissimilarity and when the pixel determined to be dissimilar is a pixel included in a change region of the image from the start to the end of a seat state change, the background model information updating unit 135 determines that the pixel is a pixel that corresponds to the background having a change, registers the information of the feature amount of the pixel determined to be dissimilar onto the background model information, and makes an update. (refer to steps S206 to S208 in FIG. 5). In contrast, in a case where the feature amount similarity determination unit 134 has determined similarity, the background model information updating unit 135 updates a frequency of occurrence of the feature amount of the pixel determined to be similar, and when the frequency of occurrence of the feature amount is a predetermined frequency or more in the image from the start to end of the seat state change, the background model information updating unit 135 determines that the pixel is a pixel constituting the image of a moving occupant and then deletes information regarding the feature amount of the pixel determined to have similarity from the background model information and thereby makes an update. (refer to steps S203 to S205 in FIG. 5).

—Object Extraction Unit—

The object extraction unit 136 extracts a foreground region from the current frame using a background difference on the basis of the background model information updated by the background model information updating unit 135 (refer to step S107 in FIG. 4).

A method based on statistics of information of the feature amount of the change region is preferable as a method for extracting the contour of the occupant. Examples of the method include a method of first extracting a foreground region from the image obtained from the image acquisition means 110 and information in the background model information DB 122, identifying a region that matches identification information of occupants stored in the identification information DB 123 from among the extracted foreground regions, and then extracting a contour of the identified foreground region as the contour of the occupant.

Specifically, the methods include an identification method by machine learning by AdaBoost using a Histograms of Oriented Gradients (HOG) feature amount, an identification method using face detection utilizing a Haar-like feature, or the like.

The object extraction unit 136 identifies the occupant from the foreground region on the basis of the identification information stored in the identification information DB 123, and then, transmits the image information of the contour of the occupant identified from the foreground region, to the autonomous driving system (refer to steps S108 and S109 in FIG. 4).

The communication means 140 is communicably connected to the autonomous driving system, and transmits the image information of the contour of the occupant to the autonomous driving system. The communication means 140 may be communicably connected to another information processing apparatus or the like.

The input means 150 receives various requests for the image processing apparatus 100 on the basis of an instruction of the control means 130.

The output means 160 displays, for example, an internal state of the image processing apparatus 100 on the basis of an instruction from the control means 130.

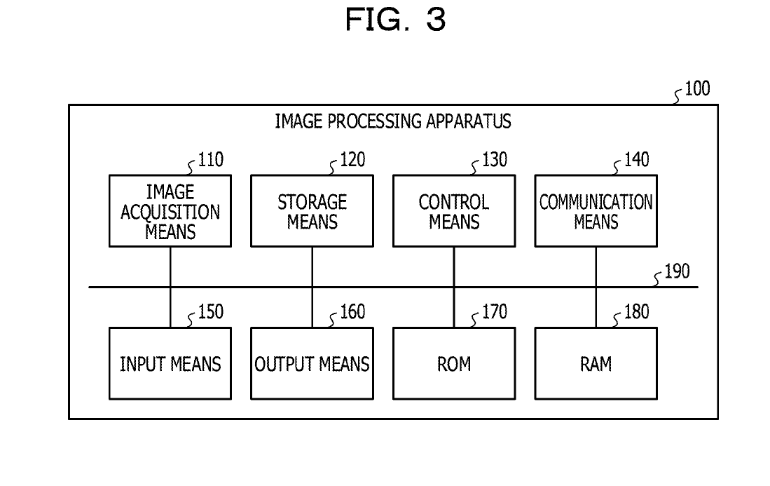

FIG. 3 is a view illustrating a hardware configuration of the image processing apparatus 100 in the first exemplary embodiment.

As illustrated in FIG. 3, the image processing apparatus 100 includes the image acquisition means 110, the storage means 120, the control means 130, the communication means 140, an input means 150, the output means 160, a read only memory (ROM) 170 and a random access memory (RAM) 180.

The individual means in the image processing apparatus 100 are communicably connected with each other via a bus 190.

Examples of the image acquisition means 110 include a digital video camera.

The storage means 120 is not particularly limited as long as it can store various types of information and is appropriately selectable according to the purpose. For example, the storage means 120 may be a portable storage device such as a compact disc (CD) drive, a digital versatile disc (DVD) drive, or a Blu-ray (registered trademark) disc (BD) drive, in addition to a solid state drive, a hard disk drive, or the like, or may be a part of a cloud being a group of computers on a network.

An example of the control means 130 is a central processing unit (CPU). A processor that executes software is hardware.

The communication means 140 may be communicably connected to another information processing apparatus or the like.

The input means 150 is not particularly limited as long as it can receive various requests for the image processing apparatus 100, and any known members can be used as appropriate, and examples include a keyboard, a mouse, a touch panel, and a microphone.

The output means 160 is not particularly limited, and any known members can be used as appropriate, and examples include a display and a speaker.

The ROM 170 stores various programs, data, or the like, necessary for the control means 130 to execute various programs stored in the storage means 120. More specifically, the ROM 170 stores a boot program such as a Basic Input/Output System (BIOS) and an Extensible Firmware Interface (EFI).

The RAM 180 is a main storage device, and functions as a work region to be expanded when various programs stored in the storage means 120 are executed by the control means 130. Examples of the RAM 180 include a dynamic random access memory (DRAM) and a static random access memory (SRAM).

FIG. 4 is a flowchart illustrating a flow of control from a point of acquisition of an image in an autonomous driving vehicle by the image processing apparatus 100 to a point of transmission by the apparatus of image information of a contour of an occupant to the autonomous driving system.

Here, a flow of control from a point of acquisition of the image inside the autonomous driving vehicle by the image processing apparatus 100 to a point of transmission by the apparatus of the image information of the contour of the occupant to the autonomous driving system will be described in accordance with the flowchart illustrated in FIG. 4 and with reference to FIG. 1.

The image processing apparatus 100 updates and stores information of the feature amount of each of pixels constituting the background in the image acquired in the past as background model information in the background model information DB 122.

In step S101, the image acquisition means 110 installed in the autonomous driving vehicle compartment photographs and acquires an image of a moving occupant on the basis of an instruction from the control means 130, and then, shifts the processing to S102. The image acquired by the image acquisition means 110 is stored in the storage means 120.

In step S102, the feature amount calculation unit 131 calculates the feature amount of each of pixels in the image acquired by the image acquisition means 110, and then, shifts the processing to step S103.

In step S103, the change region extraction unit 132 extracts a change region including the seat and occupant on the basis of difference information in pixels having a same type of feature amount for each of pixels in the image, and then, shifts the processing to S103.

In step S104, the background change image identification unit 133 determines whether the seat state change has started in the image (current frame) acquired in step S101, on the basis of the change region extracted by the change region extraction unit 132. The background change image identification unit 133 determines that the seat state change has started in the current frame, and then, shifts the processing to step S105. In a case where it is determined that the seat state change has not started in the current frame, the processing proceeds to S107.

In step S105, the background change image identification unit 133 determines whether the seat state change has finished in the current frame, on the basis of the change region in the sequentially acquired images. After determining that the seat state change has finished in the current frame, the background change image identification unit 133 shifts the processing to step S106. In a case where it is determined that the seat state change has not finished in the current frame, the processing proceeds to S101, and an image to be a succeeding frame is acquired.

In step S106, the feature amount similarity determination unit 134 and the background model information updating unit 135 performs background model information update processing and then, shifts the processing to step S107. Details of the background model information update processing will be described below with reference to FIG. 5.

In step S107, the object extraction unit 136 extracts a foreground region from the current frame using a background difference on the basis of background model information updated by the background model information update processing, and then, shifts the processing to S108.

In step S108, after identification of the occupant from the foreground region based on the identification information stored in the identification information DB 123, the object extraction unit 136 shifts the processing to S109.

In step S109, the object extraction unit 136 transmits the image information of the contour of the occupant identified from the foreground region to the autonomous driving system, and then finishes the present processing.

FIG. 5 is a flowchart illustrating an example of a flow of control of background model information update processing.

Here, a flow of control of performing background model information update processing of step S106 will be described in accordance with the flowchart illustrated in FIG. 5 and with reference to FIG. 1.

While the background model information update processing targets all the pixels of the acquired image using loop processing as illustrated in FIG. 5, the processing for one pixel will be described along the flow from steps S201 to S208.

In step S201, the feature amount similarity determination unit 134 calculates the similarity on the basis of the feature amount calculated by the feature amount calculation unit 131 in the image that the background change image identification unit 133 has identified as an image in which the seat state change has finished and the feature amount of the background model information stored in the background model information DB 122. Thereafter, the feature amount similarity determination unit 134 shifts the processing to S202. In other words, the feature amount similarity determination unit 134 determines whether the feature amounts before and after the seat state change are similar to each other.

In step S202, the feature amount similarity determination unit 134 determines whether the calculated similarity is a threshold or more. After determination that the calculated similarity is a threshold or more, the feature amount similarity determination unit 134 shifts the processing to step S203. When it is determined that the calculated similarity is not the threshold or more, the processing proceeds to S206.

In step S203, when the similarity calculated by the feature amount similarity determination unit 134 is a threshold or more and determined to be similar, the background model information updating unit 135 updates the frequency of occurrence of feature amounts of pixels determined to be similar, and then shifts the processing to step S204. The background model information updating unit 135 registers the feature amounts of the pixels determined to be similar when the feature amounts have not been registered in the registration information.

In step S204, after updating the frequency of occurrence of the feature amount of the pixel determined to be similar, the background model information updating unit 135 determines whether the frequency of occurrence is a predetermined frequency of more in the image from the start to the end of the seat state change. When it is determined that the frequency of occurrence number is a predetermined frequency or more, the background model information updating unit 135 shifts the processing to S205. When it is determined that the frequency of occurrence number is not the predetermined frequency or more, the background model information updating unit 135 shifts the processing to S208.

In step S205, when the frequency of occurrence in the pixel is a predetermined frequency or more, the background model information updating unit 135 determines the pixel as a pixel that constitutes moving occupant and deletes registration information of similar feature amount from the background model information DB 122 and stores this in the storage means 120 as a feature amount that is not a background. Thereafter, the background model information updating unit 135 shifts the processing to loop processing of determining whether processing of all pixels in the image is finished.

In the loop processing, when the control means 130 determines that the processing of all the pixels has not been finished, the processing is shifted to S201. When it is determined that the processing of all the pixels has been finished, the processing is shifted to S107 of the flowchart illustrated in FIG. 4.

In step S206, in a case where the feature amount similarity determination unit 134 determines that the calculated similarity is not the threshold or more and thus is not similar, the background model information updating unit 135 determines whether the pixel having dissimilar determination is a pixel included in a change region in an image from the start to the end of the seat state change, that is, whether there is an inter-frame difference. When it is determined that there is an inter-frame difference in the pixel, the background model information updating unit 135 shifts the processing to step S207. When it is determined that there is no inter-frame difference in the pixel, the background model information updating unit 135 shifts the processing to step S208.

In step S207, in a case where determination is made that there is an inter-frame difference in the pixel, the background model information updating unit 135 newly registers the feature amount corresponding to the pixel into the background model information DB 122 in the image for which identification of an end of seat state change is made, and thereafter, shifts the processing to S208.

In step S208, after updating information such as the average value of luminance, the standard deviation value of luminance, and the weight included in the background model information of the pixel, an image for which identification of an end of seat state change is made, the background model information updating unit 135 shifts the processing to loop processing of determining whether the processing of all the pixels of the image for which identification of completion of seat state change has been made.

In the loop processing, when the control means 130 determines that the processing of all the pixels has not been finished, the processing is shifted to S201. When it is determined that the processing of all the pixels has been finished, the processing is shifted to S107 of the flowchart illustrated in FIG. 4.

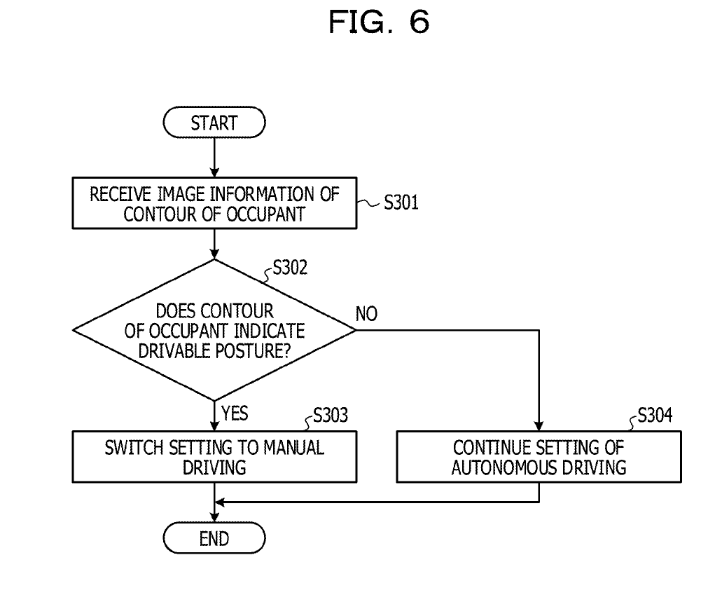

FIG. 6 is a flowchart illustrating a flow of control of determining, in the first exemplary embodiment, whether the occupant is in a drivable posture on the basis of the image information of the contour of the occupant transmitted from the image processing apparatus 100 and deciding whether to switch to manual driving.

Here, the following will be description of a flow of control of determining by the autonomous driving system whether the occupant is in a drivable posture on the basis of the image information of the contour of the occupant transmitted from the image processing apparatus 100 and deciding whether to switch to manual driving, in accordance with the flowchart in FIG. 6.

In step S301, when the image information of the contour of the occupant has been input from the image processing apparatus 100, the autonomous driving system shifts the processing to S302.

In step S302, the autonomous driving system determines whether the contour of the occupant is similar to the shape of the drivable posture on the basis of the input image information of the contour of the occupant. When it is determined that the image information of the contour of the occupant is similar to the shape of the drivable posture, the autonomous driving system shifts the processing to S303. When it is determined that the contour of the occupant is not similar to the shape of the drivable posture, the processing proceeds to S304.

In step S303, the autonomous driving system that determines that the contour of the occupant is similar to the shape of the drivable posture switches the setting from the autonomous driving to the manual driving and to pass the driving authority to the occupant, thereby finishing the present processing.

In step S304, the autonomous driving system that has determined that the contour of the occupant is not similar to the shape of the drivable posture continues the setting of the autonomous driving and finishes the present processing.

In this manner, in the first exemplary embodiment, the image processing apparatus extracts the occupant from the acquired image using the background difference on the basis of the background model information updated as described above and transmits image information of the contour of the occupant to the autonomous driving system. This enables the autonomous driving system to determine whether the occupant is in a drivable posture on the basis of the image information of the contour of the occupant and to set whether to switch to manual driving or to continue autonomous driving.

While the technology is used for an autonomous driving system in a present exemplary embodiment, application is not limited to this example, and is applicable to the monitoring to ensure safety of occupants, for example.

### Second Exemplary Embodiment

The second exemplary embodiment will describe a case of determining whether the occupant is in an abnormal posture on the basis of image information of the contour of the occupant transmitted from the image processing apparatus 100.

The image processing apparatus 100 according to the second exemplary embodiment is similar to the image processing apparatus 100 according to the first exemplary embodiment in its mechanical configuration and hardware configuration, and in a flow of control performed by the image processing apparatus 100 illustrated in FIGS. 4 and 5.

Accordingly, description of these will be omitted, and a flow of control of the autonomous driving system to which the image information of the contour of the occupant has been transmitted from the image processing apparatus 100 will be described.

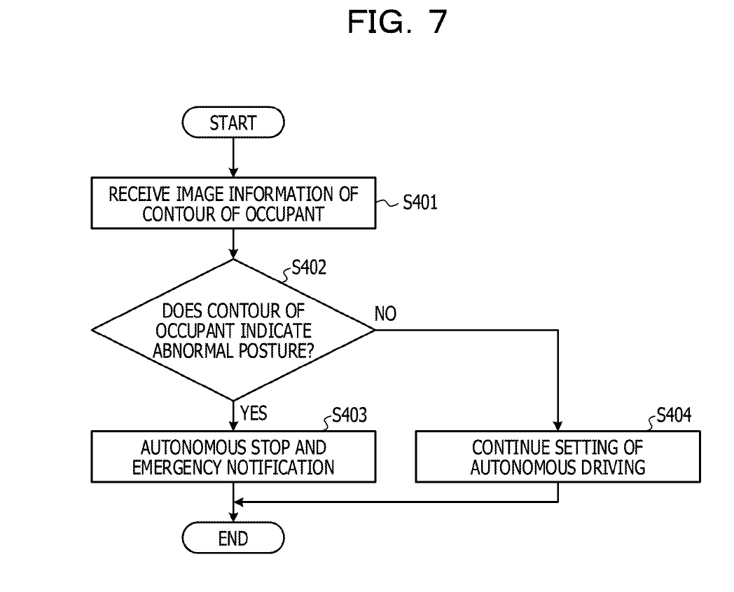

FIG. 7 is a flowchart illustrating a flow of control of determining by the autonomous driving system in the second exemplary embodiment whether the occupant is in an abnormal posture on the basis of the image information of the contour of the occupant transmitted from the image processing apparatus 100 and deciding an action to take.

Here, the following will describe a flow of control of determining by the autonomous driving system whether the occupant is in an abnormal posture on the basis of the image information of the contour of the occupant transmitted from the image processing apparatus 100 and deciding an action to take, in accordance with the flowchart in FIG. 7.

In step S401, when the image information of the contour of the occupant has been input from the image processing apparatus 100, the autonomous driving system shifts the processing to S402.

In step S402, the autonomous driving system determines whether the contour of the occupant is similar to the shape of the abnormal posture on the basis of the input image information of the contour of the occupant. When it is determined that the contour of the occupant is similar to the shape of the abnormal posture, the autonomous driving system shifts the processing to S403. When it is determined that the contour of the occupant is not similar to the shape of the abnormal posture, the processing proceeds to S404.

The abnormal posture includes, for example, a posture in which the upper body of the occupant is remarkably inclined because of lost consciousness due to epilepsy.

In step S403, after determination that the contour of the occupant is similar to the shape of the abnormal posture, the autonomous driving system autonomously stops on the emergency stop lane and makes emergency notification to a hospital or the like, so as to complete the present processing.

In step S404, after determination that the contour of the occupant is not similar to the shape of the abnormal posture, the autonomous driving system continues the autonomous driving setting, so as to complete the present processing.

In this manner, in the second exemplary embodiment, the image processing apparatus extracts the occupant from the acquired image using the background difference on the basis of the background model information updated as described above and transmits image information of the contour of the occupant to the autonomous driving system. This enables the autonomous driving system to determine whether the occupant is in an abnormal posture on the basis of the image information of the contour of the occupant and to decide whether to autonomously stop the vehicle at the emergency stop lane and make emergency notification to a hospital or the like.

While the image processing apparatus is used for an autonomous driving system in the first and second exemplary embodiments, application is not limited to this example, and can be applied to the monitoring to ensure safety of occupants in a vehicle, for example.

Regarding the above embodiment, the following notes are further disclosed.

(Note 1)

An image processing apparatus including:

an image acquisition means for sequentially acquiring an image including at least a moving object;

a storage means for storing information regarding a feature amount of each of pixels constituting a background of the object in the image acquired by the image acquisition means, as background model information; and

a control means for controlling to extract the object from the image in which the object and a part of the background change in conjunction with each other on the basis of the background model information,

in which the control means includes

a feature amount calculation unit that calculates a feature amount of each of pixels in the image acquired by the image acquisition means,

a change region extraction unit that extracts a change region including the background and the object for each of the images on the basis of difference information in pixels having a same type of feature amount for each of pixels in the image sequentially acquired,

a background change image identification unit that identifies the image from a start to an end of the partial change in the background,

a feature amount similarity determination unit that determines whether the feature amount calculated by the feature amount calculation unit is similar to the feature amount of the background model information stored in the storage means, for each of the pixels of the image for which the background change image identification unit has identified the end of the partial change in the background,

a background model information updating unit that, in a case where the feature amount similarity determination unit has determined dissimilarity and when the pixel determined to be dissimilar is the pixel included in the change region of the image from the start to the end of the partial change in the background, determines that the pixel is the pixel that corresponds to the background having a change, registers the information of the feature amount of the pixel determined to be dissimilar onto the background model information, and makes an update, and

an object extraction unit that extracts the object from the image using a background difference on the basis of the updated background model information.

(Note 2)

The image processing apparatus according to note 1,

in which, in a case where the feature amount similarity determination unit has determined similarity, the background model information updating unit updates a frequency of occurrence of the feature amount of the pixel determined to be similar, and when the frequency of occurrence in the pixel is a predetermined frequency or more in the image from the start to the end of the partial change in the background, the background model information updating unit determines that the feature amount is a feature amount of the pixel constituting the image of the moving object and then deletes information regarding the feature amount of the pixel determined to have similarity from the background model information and makes an update.

(Note 3)

The image processing apparatus according to any of notes 1 to 2,

in which the object extraction unit does not extract the object from the image acquired by the image acquisition means in duration from the start to the end of the partial change in the background.

(Note 4)

The image processing apparatus according to any of notes 1 to 3,

in which the object extraction unit extracts a foreground region from the image on the basis of the updated background model information, and extracts the object from the image acquired by the image acquisition means on the basis of a statistic of information of the feature amount in the foreground region.

(Note 5)

The image processing apparatus according to any of notes 1 to 4,

in which the image acquisition means captures an image of an occupant in a vehicle,

the object is the occupant, and

the partial change in the background is a change when the occupant performs one or both of reclining and sliding a seat in the vehicle.

(Note 6)

An image processing method including:

an image acquisition process of sequentially acquiring an image including at least a moving object;

a storage process of storing information regarding a feature amount of each of pixels constituting a background of the object in the image acquired by the image acquisition process, as background model information; and

a control process of controlling to extract the object from the image in which the object and a part of the background change in conjunction with each other on the basis of the background model information,

in which the control process includes

a feature amount calculation processing of calculating a feature amount of each of pixels in the image acquired by the image acquisition process,

a change region extraction processing of extracting a change region including the background and the object for each of the images on the basis of difference information in pixels having a same type of feature amount for each of pixels in the image sequentially acquired,

a background change image identification processing of identifying the image from a start to an end of the partial change in the background,

a feature amount similarity determination processing of determining whether the feature amount calculated by the feature amount calculation process is similar to the feature amount of the background model information stored in the storage process, for each of the pixels of the image for which the background change image identification processing has identified the end of the partial change in the background,

a background model information update processing of, in a case where the feature amount similarity determination processing has determined dissimilarity and when the pixel determined to be dissimilar is the pixel included in the change region of the image from the start to the end of the partial change in the background, determining that the pixel is the pixel that corresponds to the background having a change, registering the information of the feature amount of the pixel determined to be dissimilar onto the background model information, and making an update, and

an object extraction processing of extracting the object from the image using a background difference on the basis of the updated background model information.

(Note 7)

An image processing program causing a computer to execute processing including:

sequentially acquiring an image including at least a moving object;

storing information regarding a feature amount of each of pixels constituting a background of the object in the acquired image, as background model information; and

controlling to extract the object from the image in which the object and a part of the background change in conjunction with each other on the basis of the stored background model information,

the image processing program causing a computer to further execute processing including:

calculating a feature amount of each of pixels in the acquired image;

extracting a change region including the background and the object for each of the images on the basis of difference information in pixels having a same type of feature amount for each of pixels in the image sequentially acquired;

identifying the image from a start to an end of the partial change in the background;

determining whether the calculated feature amount is similar to the feature amount of the stored background model information, for each of the pixels of the image for which the end of the partial change in the background has been identified;

in a case where determination of dissimilarity has been made and when the pixel determined to be dissimilar is the pixel included in the change region of the image from the start to the end of the partial change in the background, determining that the pixel is the pixel that corresponds to the background having a change, registering the information of the feature amount of the pixel determined to be dissimilar onto the background model information, and making an update; and

extracting the object from the image using a background difference on the basis of the updated background model information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing apparatus comprising:
a memory;
a processor coupled to the memory and configured to perform a processing of:
acquiring an image including at least a moving object;
storing information regarding a feature amount of each of pixels constituting a background of the object in the acquired image as background model information in a storage;
controlling to extract the object from the image in which the object and a part of the background change in conjunction with each other based on the background model information;
calculating a feature amount of each of pixels in the acquired image;
extracting a change region including the background and the object for each of the images based on difference information in pixels having a same type of feature amount for each of pixels in the image sequentially acquired;
identifying the image from a start to an end of the partial change in the background;
determining whether the calculated feature amount is similar to the feature amount of the background model information stored in the storage, for each of the pixels of the image in which the end of the partial change in the background is identified;
when determining dissimilarity and when the pixel determined to be dissimilar is the pixel included in the change region of the image from the start to the end of the partial change in the background, determining that the pixel is the pixel that corresponds to the background having a change;
registering the information of the feature amount of the pixel determined to be dissimilar onto the background model information to update the background model information; and
extracting the object from the image using a background difference based on the updated background model information.

2. The image processing apparatus according to claim 1,
Wherein the processing further includes:
updating, when determining similarity, a frequency of occurrence of the feature amount of the pixel determined to be similar; and
determining, when the frequency of occurrence in the pixel is a predetermined frequency or more in the image from the start to the end of the partial change in the background, that the feature amount is a feature amount of the pixel constituting the image of the moving object; and
deleting information regarding the feature amount of the pixel determined to have similarity from the background model information to update the background model information.

3. The image processing apparatus according to claim 1,
wherein the object is not extracted from the acquired image in duration from the start to the end of the partial change in the background.

4. The image processing apparatus according to claim 1,
wherein a foreground region is extracted from the image based on the updated background model information, and the object is extracted from the acquired image based on a statistic of information of the feature amount in the foreground region.

5. The image processing apparatus according to claim 1,
wherein an image of an occupant in a vehicle is captured,
the object is the occupant, and
the partial change in the background is a change when the occupant performs one or both of reclining and sliding a seat in the vehicle.

6. An image processing method comprising:
an image acquisition process of sequentially acquiring an image including at least a moving object;
a storage process of storing information regarding a feature amount of each of pixels constituting a background of the object in the acquired image, as background model information; and
a control process of controlling to extract the object from the image in which the object and a part of the background change in conjunction with each other on a basis of the background model information,
wherein the control process includes:
feature amount calculation processing of calculating a feature amount of each of pixels in the acquired image acquired,
change region extraction processing of extracting a change region including the background and the object for each of the images on a basis of difference information in pixels having a same type of feature amount for each of pixels in the image sequentially acquired,
background change image identification processing of identifying the image from a start to an end of the partial change in the background,
feature amount similarity determination processing of determining whether the feature amount calculated by the feature amount calculation processing is similar to the feature amount of the background model information stored in the storage process, for each of the pixels of the image for which the background change image identification processing has identified the end of the partial change in the background,
background model information update processing of, in a case where the feature amount similarity determination processing has determined dissimilarity and when the pixel determined to be dissimilar is the pixel included in the change region of the image from the start to the end of the partial change in the background, determining that the pixel is the pixel that corresponds to the background having a change, registering the information of the feature amount of the pixel determined to be dissimilar onto the background model information, and making an update, and
object extraction processing of extracting the object from the image using a background difference on a basis of the updated background model information.

7. The image processing method according to claim 6,
wherein the control process further includes:
updating, when determining similarity, a frequency of occurrence of the feature amount of the pixel determined to be similar; and
determining, when the frequency of occurrence in the pixel is a predetermined frequency or more in the image from the start to the end of the partial change in the background, that the feature amount is a feature amount of the pixel constituting the image of the moving object; and
deleting information regarding the feature amount of the pixel determined to have similarity from the background model information to update the background model information.

8. The image processing method according to claim 6,
wherein the object is not extracted from the acquired image in duration from the start to the end of the partial change in the background.

9. The image processing method according to claim 6,
wherein a foreground region is extracted from the image based on the updated background model information, and the object is extracted from the acquired image based on a statistic of information of the feature amount in the foreground region.

10. The image processing method according to claim 6,
wherein an image of an occupant in a vehicle is captured,
the object is the occupant, and
the partial change in the background is a change when the occupant performs one or both of reclining and sliding a seat in the vehicle.

11. A non-transitory computer-readable recording medium recording an image processing program causing a computer to execute processing comprising:
sequentially acquiring an image including at least a moving object;
storing information regarding a feature amount of each of pixels constituting a background of the object in the acquired image, as background model information; and
controlling to extract the object from the image in which the object and a part of the background change in conjunction with each other on a basis of the stored background model information,
the image processing program causing a computer to further execute processing comprising:
calculating a feature amount of each of pixels in the acquired image;
extracting a change region including the background and the object for each of the images on a basis of difference information in pixels having a same type of feature amount for each of pixels in the image sequentially acquired;
identifying the image from a start to an end of the partial change in the background;
determining whether the calculated feature amount is similar to the feature amount of the stored background model information, for each of the pixels of the image for which the end of the partial change in the background has been identified;
in a case where determination of dissimilarity has been made and when the pixel determined to be dissimilar is the pixel included in the change region of the image from the start to the end of the partial change in the background, determining that the pixel is the pixel that corresponds to the background having a change, registering the information of the feature amount of the pixel determined to be dissimilar onto the background model information, and making an update; and
extracting the object from the image using a background difference on a basis of the updated background model information.

12. The non-transitory computer-readable recording medium according to claim 11,
wherein the processing further includes:
updating, when determining similarity, a frequency of occurrence of the feature amount of the pixel determined to be similar; and
determining, when the frequency of occurrence in the pixel is a predetermined frequency or more in the image from the start to the end of the partial change in the background, that the feature amount is a feature amount of the pixel constituting the image of the moving object; and
deleting information regarding the feature amount of the pixel determined to have similarity from the background model information to update the background model information.

13. The non-transitory computer-readable recording medium according to claim 11,
wherein the object is not extracted from the acquired image in duration from the start to the end of the partial change in the background.

14. The non-transitory computer-readable recording medium according to claim 11,
wherein a foreground region is extracted from the image based on the updated background model information, and the object is extracted from the acquired image based on a statistic of information of the feature amount in the foreground region.

15. The non-transitory computer-readable recording medium according to claim 11,
wherein an image of an occupant in a vehicle is captured,
the object is the occupant, and
the partial change in the background is a change when the occupant performs one or both of reclining and sliding a seat in the vehicle.
